(19) United States
(12) Patent Application Publication
(10) Pub. No.: US 2013/0222080 A1
(43) Pub. Date: Aug. 29, 2013

(54) NON-RESONANT NODE FILTER

(71) Applicants: Raja Reddy KATIPALLY, Cheshire, CT (US); Andrzej E. STANEK, New Haven, CT (US)

(72) Inventors: Raja Reddy KATIPALLY, Cheshire, CT (US); Andrzej E. STANEK, New Haven, CT (US)

(73) Assignee: RADIO FREQUENCY SYSTEMS, INC., Meriden, CT (US)

(21) Appl. No.: 13/404,298

(22) Filed: Feb. 24, 2012

(51) Int. Cl. H01P 1/20; H01P 11/00

(52) U.S. Cl. 333/203; 29/600

(57) ABSTRACT

Various exemplary embodiments relate to a filter configured to operate in an operational frequency range. The filter may include a mainline, at least one combline resonator coupled to the mainline, an input port coupled to the mainline, and an output port coupled to the mainline. The mainline may include at least one non-resonant node. The at least one non-resonant node may be configured to resonate in a frequency range outside of the operational frequency range of the filter, and the at least one combline resonator may be configured to resonate in a frequency range within the operational frequency range of the filter.

### TECHNICAL FIELD

Various exemplary embodiments disclosed herein relate generally to cavity filters for radio, microwave, or other high frequency signals.

### BACKGROUND

Cavity structures may act as resonant circuits for electromagnetic signals. One or more cavities may be combined to create a filter.

### SUMMARY

A brief summary of various exemplary embodiments is presented. Some simplifications and omissions may be made in the following summary, which is intended to highlight and introduce some aspects of the various exemplary embodiments, but not to limit the scope of the invention. Detailed descriptions of exemplary embodiments adequate to allow those of ordinary skill in the art to make and use the inventive concepts will follow in later sections.

Various exemplary embodiments relate to a filter configured to operate in an operational frequency range, including: a mainline comprising at least one non-resonant node, wherein the at least one non-resonant node is configured to resonate in a frequency range outside of the operational frequency range of the filter; at least one combline resonator coupled to the mainline, wherein the at least one combline resonator is configured to resonate in a frequency range within the operational frequency range of the filter; an input port coupled to the mainline; and an output port coupled to the mainline.

In some embodiments, the mainline comprises at least two non-resonant nodes. In some embodiments, the filter further includes at least two combline resonators, wherein a first combline resonator is coupled to a first non-resonant node, and a second combline resonator is coupled to a second non-resonant node. In some embodiments, the filter rejects a first range of frequencies within the operational frequency range based on a first tuning of the filter, and wherein the filter rejects a second range of frequencies within the operational frequency range based on a second tuning of the filter. In some embodiments, the at least one non-resonant node and the at least one combline resonator are integral to the filter.

Various exemplary embodiments further relate to a method for manufacturing a filter configured to operate in an operational frequency range, the method including: forming a mainline comprising at least one non-resonant node, wherein the at least one non-resonant node is configured to resonate in a frequency range outside of the operational frequency range of the filter; forming at least one combline resonator coupled to the mainline, wherein the at least one combline resonator is configured to resonate in a frequency range within the operational frequency range of the filter; forming an input port coupled to the mainline; and forming an output port coupled to the mainline.

In some embodiments, the mainline comprises at least two non-resonant nodes. In some embodiments, the method further includes forming at least two combline resonators, wherein a first combline resonator is coupled to a first non-resonant node, and a second combline resonator is coupled to a second non-resonant node. In some embodiments, the filter rejects a first range of frequencies within the operational frequency range based on a first tuning of the filter, and wherein the filter rejects a second range of frequencies within the operational frequency range based on a second tuning of the filter. In some embodiments, the at least one non-resonant node and the at least one combline resonator are integral to the filter.

### BRIEF DESCRIPTION OF THE DRAWINGS

In order to better understand various exemplary embodiments, reference is made to the accompanying drawings, wherein:

FIG. 1 illustrates an embodiment of a conventional combline filter;

FIG. 2 illustrates an example of the frequency response of a conventional combline filter;

FIG. 3 illustrates an embodiment of a conventional notch filter;

FIG. 4 illustrates an example of the frequency response of a conventional notch filter;

FIG. 5 illustrates an embodiment of a non-resonant node filter;

FIG. 6A illustrates an example of the frequency responses of the non-resonant node filter; and

FIG. 6B illustrates another example of the frequency responses of the non-resonant node filter.

### DETAILED DESCRIPTION

Referring now to the drawings, in which like numerals refer to like components or steps, there are disclosed broad aspects of various exemplary embodiments.

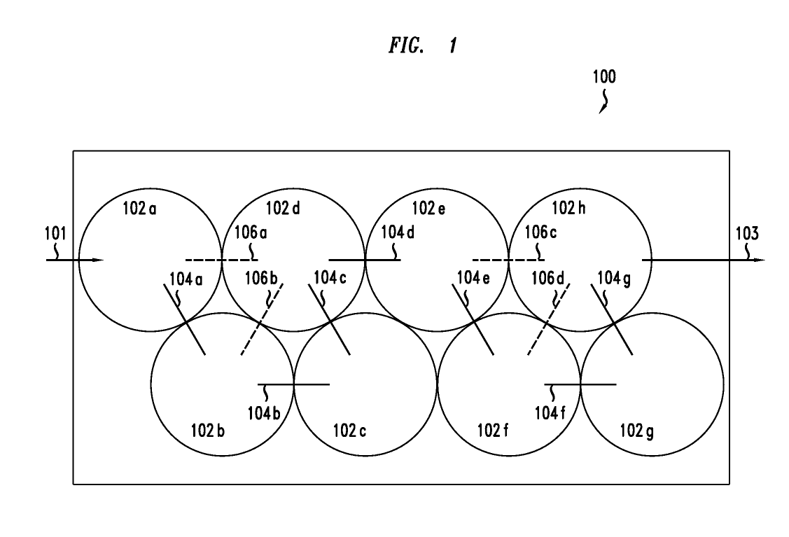

FIG. 1 illustrates an embodiment of a conventional combline filter 100. The conventional combline filter 100 may include eight combline resonators 102a-102h. A signal may be input to the combline resonator 102a via an input port 101. A filtered signal may exit the combline resonator 102h via an output port 103. Seven mainline coupling elements 104a-104g may couple the eight combline resonators 102a-102h. Four cross-coupling elements 106a-106d may couple pairs of combline resonators. Cross-coupling element 106a may couple combline resonator 102d and combline resonator 102d. Cross-coupling element 106b may couple combline resonator 102b and combline resonator 102d. Cross-coupling element 106c may couple combline resonator 102e and combline resonator 102h. And cross-coupling element 106d may couple combline resonator 102f and combline resonator 102h.

While eight combline resonators, seven mainline coupling elements, and four cross-coupling elements are shown, the number of combline resonators, mainline coupling elements, and cross-coupling elements may vary based on a desired capability of the conventional combline filter 100.

The mainline coupling elements 104a-104g and the cross-coupling elements 106a-106d may be positive or negative depending on a desired frequency rejection. For example, if greater frequency rejection is desired for frequencies above the passband of the combline filter 100, then the mainline coupling elements 104a-104g and the cross-coupling elements 106a-106d may all be positive. If greater frequency rejection is desired for frequencies below the passband of the combline filter 100, then the seven mainline coupling elements 104a-104g may be positive, cross-coupling elements 106a and 106c may be positive, and cross-coupling elements 106b and 106d may be negative.

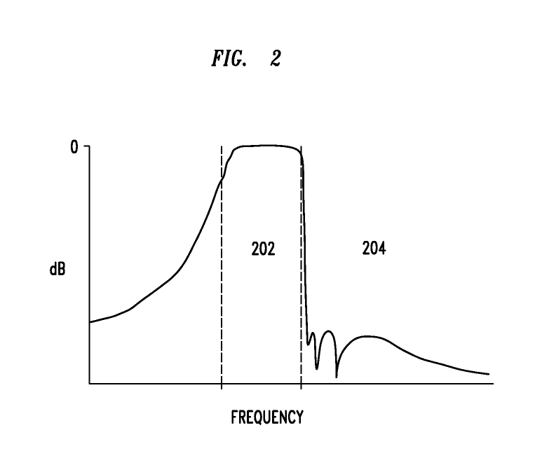

FIG. 2 illustrates an example of the frequency response of a conventional combline filter. A passband region 202 may be a range of frequencies that are not significantly filtered by the combline filter. A rejection region 204 may be a range of frequencies that are minimized by the combline filter. The example of FIG. 2 illustrates a combline filter with greater frequency rejection above the passband region 202.

Achieving a desired frequency rejection near a passband with the conventional combline filter 100 may require precise design of the four cross-coupling elements 106a-106d and other filter components. Due to the precise design requirements, the conventional combline filter 100 may have a complex and time-consuming assembly process.

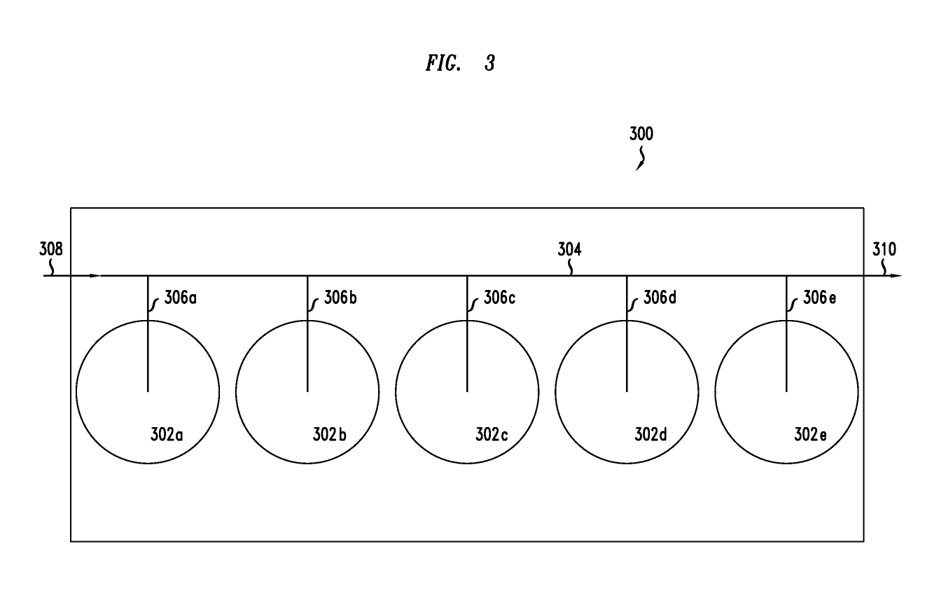

FIG. 3 illustrates an embodiment of a conventional notch filter 300. The conventional notch filter 300 may include five combline resonators 302a-302e arranged in a notch configuration. Each of the five combline resonators 302a-302e may be coupled to a transmission line 304 by five coupling strips 306a-306e. A signal may be input to the transmission line 304 via an input port 308. A filtered signal may exit the transmission line 304 via an output port 310.

While five combline resonators and five coupling strips are shown, the number of combline resonators and coupling strips may vary based on a desired capability of the conventional notch filter 300.

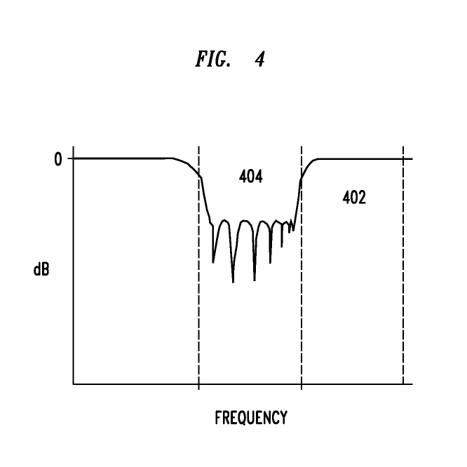

FIG. 4 illustrates an example of the frequency response of a conventional notch filter. A passband region 402 may be a range of frequencies that are not significantly filtered by the combline filter. A rejection region 404 may be a range of frequencies that are minimized by the notch filter. The example of FIG. 4 illustrates a notch filter with greater frequency rejection below the passband region 402.

The combline resonators 302a-302e, transmission line 304, and coupling strips 306a-306e of the conventional notch filter 300 may each be individual and separate components. Each component may need to be individually assembled and tuned for the conventional notch filter 300 to achieve a desired frequency rejection. Due to the amount of separate components and involved tuning process, the conventional notch filter 300 may have a complex and time-consuming assembly process.

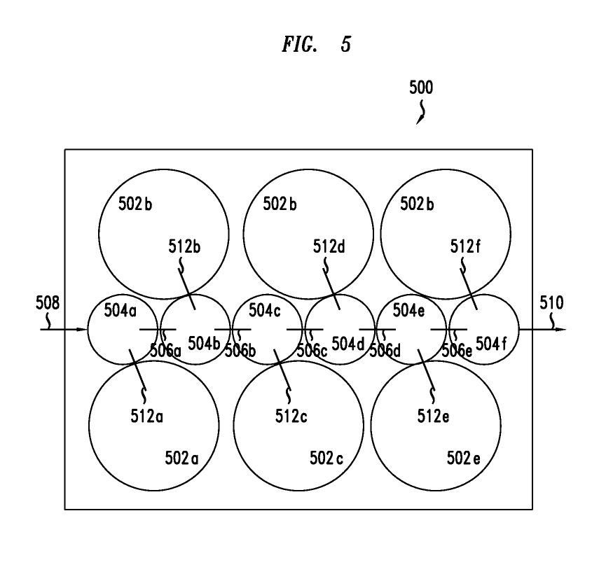

FIG. 5 illustrates an embodiment of a non-resonant node filter 500. The non-resonant node filter 500 may include six combline resonators 502a-502f and six non-resonant nodes 504a-504f. The six non-resonant nodes 504a-504f may be coupled to each other by five mainline coupling elements 506a-506e. The non-resonant nodes 504a-504f may be configured to resonate at frequencies far outside of a desired passband. By not resonating in the desired passband, the six non-resonant nodes 504a-504f and five mainline coupling elements 506a-506e may form a mainline. A signal may be input to the mainline via an input port 508 connected to non-resonant node 504a. A filtered signal may exit the mainline via an output port 510 connected to non-resonant node 504f.

The six combline resonators 502a-502f may be coupled to the mainline via six combline coupling elements 512a-512f. Combline coupling element 512a may couple combline resonator 502a to non-resonate node 504a. Combline coupling element 512b may couple combline resonator 502b to non-resonate node 504b. Combline coupling element 512c may couple combline resonator 502c to non-resonate node 504c. Combline coupling element 512d may couple combline resonator 502d to non-resonate node 504d. Combline coupling element 512e may couple combline resonator 502e to non-resonate node 504e. Combline coupling element 512f may couple combline resonator 502f to non-resonate node 504f. The mainline coupling elements 506a-506f and combline coupling elements 512a-512f may be the same type of coupling elements.

While six combline resonators, six non-resonate nodes, five mainline coupling elements, and six combline coupling elements are shown, the number of combline resonators, non-resonate nodes, mainline coupling elements, and combline coupling elements may vary based upon a desired capability of the non-resonate node filter 500.

The combline resonators 502a-502f, non-resonant nodes 504a-504f, mainline coupling elements 506a-506e, and combline coupling elements 512a-512f may be integral parts of the non-resonant node filter 500. The integral parts of the non-resonant node filter 500 may allow the non-resonant node filter 500 to be less complex to assemble and tune than the conventional combline filter 100 and conventional notch filter 300.

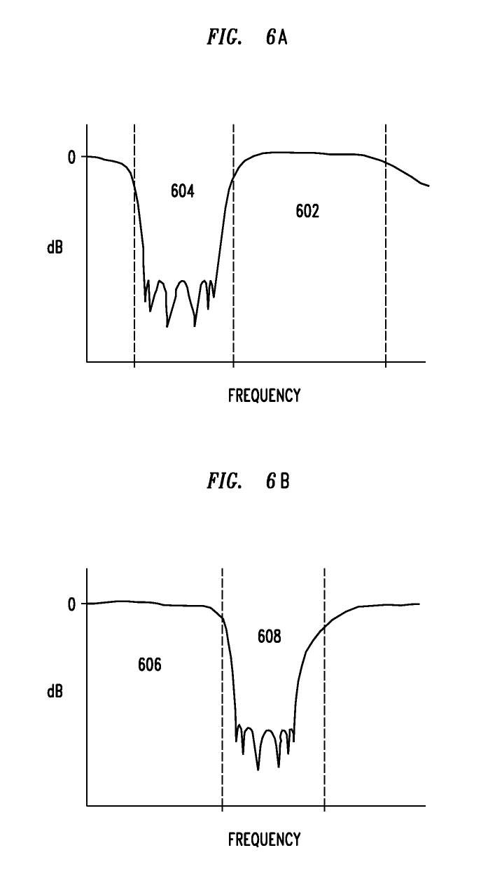

FIGS. 6A and 6B illustrate examples of frequency responses that may be achieved with the non-resonant node filter 500. The example of FIG. 6A may have a rejection region 604 below a passband region 602. The rejection region 604 may be a range of frequencies that may be minimized based on a tuning of the non-resonant node filter 500. The frequencies in the passband region 602 may not be significantly filtered by the non-resonant node filter 500 when the non-resonant node filter 500 is tuned to the rejection region 604.

The example of FIG. 6B may have a rejection region 608 above a passband region 606. The rejection region 608 may be a range of frequencies that may be minimized based on a different tuning of the non-resonant node filter 500 than the example of FIG. 6A. The frequencies in the passband region 606 may not be significantly filtered by the non-resonant node filter 500 when the non-resonant node filter 500 is tuned to the rejection region 608. In this way, the non-resonant node filter 500 may reject different ranges of frequencies based upon the tuning of the non-resonant node filter 500. The components of the non-resonant node filter 500 may not need to be redesigned for the non-resonant node filter 500 to reject different ranges of frequencies, only the tuning of the non-resonant node filter 500 may need to be adjusted. The tuning of the non-resonant node filter 500 may be adjusted by tuning the frequencies of the combline resonators 502a-502f and/or the values of the combline coupling elements 512a-512f. Further modification to the design of the non-resonant node filter 500 may not be necessary to shift the rejection regions above or below a passband region.

According to the foregoing, various exemplary embodiments provide for a filter that may be easier to assemble and tune than conventional filters. Further, various exemplary embodiments provide for a filter that may be easier to configure to reject different ranges of frequencies than conventional filters.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A filter configured to operate in an operational frequency range, comprising:
a mainline comprising at least one non-resonant node, wherein the at least one non-resonant node is configured to resonate in a frequency range outside of the operational frequency range of the filter;
at least one combline resonator coupled to the mainline, wherein the at least one combline resonator is configured to resonate in a frequency range within the operational frequency range of the filter;
an input port coupled to the mainline; and
an output port coupled to the mainline.

2. The filter of claim 1, wherein the mainline comprises at least two non-resonant nodes.

3. The filter of claim 2, further comprising at least two combline resonators, wherein a first combline resonator is coupled to a first non-resonant node, and a second combline resonator is coupled to a second non-resonant node.

4. The filter of claim 1, wherein the filter rejects a first range of frequencies within the operational frequency range based on a first tuning of the filter, and wherein the filter rejects a second range of frequencies within the operational frequency range based on a second tuning of the filter.

5. The filter of claim 1, wherein the at least one non-resonant node and the at least one combline resonator are integral to the filter.

6. A method for manufacturing a filter configured to operate in an operational frequency range, the method comprising:
forming a mainline comprising at least one non-resonant node, wherein the at least one non-resonant node is configured to resonate in a frequency range outside of the operational frequency range of the filter;
forming at least one combline resonator coupled to the mainline, wherein the at least one combline resonator is configured to resonate in a frequency range within the operational frequency range of the filter;
forming an input port coupled to the mainline; and
forming an output port coupled to the mainline.

7. The method of claim 6, wherein the mainline comprises at least two non-resonant nodes.

8. The method of claim 7, further comprising forming at least two combline resonators, wherein a first combline resonator is coupled to a first non-resonant node, and a second combline resonator is coupled to a second non-resonant node.

9. The method of claim 6, wherein the filter rejects a first range of frequencies within the operational frequency range based on a first tuning of the filter, and wherein the filter rejects a second range of frequencies within the operational frequency range based on a second tuning of the filter.

10. The method of claim 6, wherein the at least one non-resonant node and the at least one combline resonator are integral to the filter.
